(19) United States
(12) Patent Application Publication
(10) Pub. No.: US 2002/0076189 A1
(43) Pub. Date: Jun. 20, 2002

(54) Method for preparing optical fibers for connection to other fibers or to planar waveguides and device for such connection

(75) Inventors: David Andrew McMullin, Ottawa (CA); James William Theodore Wagner, Ottawa (CA); James P. Calogeracos, Ottawa (CA)

Correspondence Address: FRIEDRICH KUEFFNER, SUITE 1921, 342 MADISON AVENUE, NEW YORK, NY, 10173, US

(73) Assignee: Zenastra Photonics Inc.

(21) Appl. No.: 09/992,898

(22) Filed: Nov. 6, 2001

(30) Foreign Application Priority Data
Nov. 7, 2000 (CA) 2,325,424

(51) Int. Cl. G02B 6/00

(52) U.S. Cl. 385/137

(57) ABSTRACT

A substrate is provided herein for supporting at least one optical fiber, and preferably a plurality of parallel optical fibers. The substrate includes a base substrate of a suitable material a longitudinally-extending strain-relief area at one end thereof along a longitudinal axis thereof at least one longitudinally-extending groove, and preferably a plurality of parallel grooves, along the longitudinally-extending axis, and abutting the strain-relief area 10 and a first and optionally also a second transversely-extending trench across the substrate. Two such substrates may provide a bottom plate and a top plate, which are superposed to provide a precursor sandwich which supports one or more optical fibers. The precursor sandwich comprises the top plate which is superposed over the bottom plate, with one or more optical fibers therebetween in the strain-relief area, and with one or more bare exposed optical fibers in the longitudinally-extending groove or grooves. Further, a minor section of the top plate and the bottom plate of the precursor sandwich have been glued together. This precursor sandwich can be further processed to provide useful half-sandwiches and full sandwiches.

### BACKGROUND OF THE INVENTION

1. Field of the Invention

This invention relates to methods for preparing multiple optical fibers, also referred to as fiber arrays, for interconnection to other optical fibers, or to waveguides fabricated on a substrate constructed from silica, polymer, silicon, or other light guiding materials. The invention also relates to fiber connectors in general, and in particular to devices for interconnecting fibers and planar waveguides.

2 Description of the Prior Art

U.S. Pat. No. 5,787,214 patented Jul. 28, 1998 by Harpin et al provided a connection between an integrated optical waveguide and an optical fiber. That connection has a layer of silicon in which a rib waveguide is formed separated from a substrate by a layer of silicon dioxide. A V-groove is formed in the substrate for receiving an optical fiber, and the V-groove is arranged to align the optical fiber at a predetermined angle with respect to the waveguide. The rib waveguide and the underlying layer of silicon dioxide are formed to overhang the end of the V-groove so that the end of the waveguide is in close proximity with the end of an optical fiber positioned in the V-groove.

U.S. Pat. No. 6,112,002 patented Aug. 29, 2001 by Tabachi provided a semiconductor laser and an optical waveguide of an optical coupler, formed on a substrate. These are optically coupled with each other by aligning their positions horizontally by using a plurality of laser elements and cores for the laser and the waveguide respectively and arranging them in an array respectively so that a difference between their pitches is less than double of tolerance tolerated for optically coupling with each other. The waveguide has a composite core composed of a main core, a sub core surrounding the main core and having a refractive index lower than that of the main core; and a cladding layer surrounding the sub core and having a refractive index lower than that of the sub core.

U.S. Pat. No. 6,185,348 patented Feb. 2001 provided an apparatus and method for assembling a multifiber interconnection circuit where the circuit includes at least one elongated member disposed between a first cover member and a second cover member. The apparatus included a template, a receiving member, and a transfer member. The template had a first end and a second end and a means for routing an elongated member, such as an optical fiber, from the first end of the template to the second end of the template. The receiving member was arranged and configured to receive the optical fiber engaged by the template. The transfer member was configured to support the receiving member for reception of the optical fiber.

Canadian Patent Application No. 2,258,103 shows how to make an optical connector by precisely embedding optical fibers in a substrate using lithography, molding, laser, chemical or mechanical micromachining, then using a covering adhesive or the like to keep the fibers in place. The ends of the substrate are cut off forming optical connectors with precisely aligned fiber faces that may be polished. This prior art method produces an array of fibers which, however are not angled, not exposed, and are intended for re-connection to the same substrate from which they were cut.

### SUMMARY OF THE INVENTION

### Aims of the Invention

This invention aims to provide an efficient method for preparing multiple optical fibers, also referred to as fiber arrays, for interconnection to optical fibers, or to waveguides fabricated on a substrate constructed from silica, polymer, silicon, or other suitable light-guiding materials.

### Statement of Invention

The present invention provides a method for preparing a substrate for supporting at least one optical fiber. The method includes providing a base substrate of a suitable material. A longitudinally-extending, strain-relief area is formed at one end thereof along a longitudinal axis thereof At least one longitudinally-extending groove is formed along the longitudinally-extending axis, that at least one longitudinally-extending groove abutting the strain-relief area. At least a first transversely-extending trench is formed across the substrate, prior to positioning the at least one optical fiber thereon.

The present invention also provides a method for preparing a substrate for supporting a plurality of optical fibers. That method includes a base substrate of a suitable material. A longitudinally-extending, strain-relief area is provided one end thereof along a longitudinal axis thereof A plurality of parallel, longitudinally-extending grooves is provided along the longitudinally-extending axis, those longitudinally-extending grooves abutting the strain-relief area. At least a first transversely-extending trench is formed across the substrate, prior to positioning the plurality of optical fibers thereon.

The present invention also provides a method for preparing an element which supports at least one optical fiber. That method include the first step of providing a bottom plate in the form of a base substrate of a suitable material, providing a longitudinally-extending strain-relief area at one end thereof along a longitudinal axis thereof, providing at least one longitudinally-extending groove along the longitudinally-extending axis, that at least one longitudinally-extending groove abutting the strain-relief area, and providing at least a first transversely-extending trench across said substrate.

The next step involves providing a top plate in the form of a base substrate of a suitable material, providing a longitudinally-extending strain-relief area at one end thereof along a longitudinal axis thereof, providing at least one longitudinally-extending groove along the longitudinally-extending axis, that at least one longitudinally-extending groove abutting the strain-relief area, and providing at least a first transversely-extending trench across the substrate.

The next step involves disposing at least one optical fiber within the strain-relief area of either the bottom plate or the top plate and disposing at least one bare optical fiber within the longitudinally-extending groove of either the bottom plate or the top plate.

The final step involves preparing a precursor sandwich by superposing the top plate over the bottom plate with the at least one optical fiber therebetween in the strain-relief areas and with the at least one bare exposed optical fiber in the grooves and with a minor section of the top plate and the bottom plate of the precursor sandwich being glued together.

The present invention also provides a method for preparing an element which supports a plurality of optical fibers. That method includes the first step of providing a bottom plate in the form of a base substrate of a suitable material, providing a longitudinally-extending strain-relief area at one end thereof along a longitudinally axis thereof, providing a plurality of parallel, longitudinally-extending grooves along the longitudinally-extending axis, that plurality of parallel longitudinally-extending grooves abutting the strain-relief area, and providing at least a first transversely-extending trench across the substrate.

The next step involves providing a top plate in the form of a base substrate of a suitable material, providing a longitudinally-extending strain-relief area at one end thereof along a longitudinal axis thereof, providing a plurality of parallel longitudinally-extending grooves along the longitudinally-extending axis the plurality of parallel longitudinally-extending grooves abutting the strain-relief area, and providing at least a first transversely-extending trench across the substrate.

The next step involves disposing an array of optical fibers within the strain-relief area of either the bottom plate or the top plate, and disposing a plurality of parallel bare optical fibers within the parallel longitudinally-extending grooves of either the bottom plate or the top plate.

The final step involves preparing a precursor sandwich by superposing the top plate over the bottom plate with the array of optical fibers therebetween in the strain-relief areas and with the plurality of parallel bare exposed optical fibers in the grooves, and with a minor section of the top plate and the bottom plate and the precursor sandwich being glued together.

The present invention also provides a method for preparing an element which supports at least one optical fiber. That method includes the first step of providing a bottom plate in the form of a base substrate of a suitable material, providing a longitudinally-extending strain-relief area at one end thereof along a longitudinal axis thereof, providing at least one longitudinally-extending groove along the longitudinally-extending axis, the at least one longitudinally-extending groove abutting the strain-relief area, providing a first transversely-extending trench across the substrate, and providing a second trench extending transversely across the substrate at a location remote from the first trench and adjacent an end of the substrate which is remote from the first trench.

The next step includes providing a top plate in the form of a base substrate of a suitable material, providing a longitudinally-extending strain-relief area at one end thereof along a longitudinally-extending axis thereof, providing at least one longitudinally-extending groove along the longitudinally-extending axis, the at least one longitudinally-extending groove abutting the strain-relief area, providing a first transversely-extending trench across the substrate, and providing a second trench extending transversely across the substrate at a location remote from the first trench and adjacent an end of the substrate which is remote from the first trench.

The next step includes disposing at least one optical fiber within the strain-relief area of either the bottom plate or the top plate and disposing at least one bare optical fiber within the longitudinally-extending groove of either the bottom plate or the top plate. The preparing a precursor sandwich by superposing the top plate over the bottom plate with the at least one optical fiber therebetween in the strain-relief areas and with the at least one bare exposed optical fiber in the grooves, and with a minor section of the top plate and the bottom plate of the precursor sandwich being glued together.

The present invention also provides a method for preparing an element which supports a plurality of optical fibers. The method includes the first step of providing a bottom plate in the form of a base substrate of a suitable material, providing a longitudinally-extending strain-relief area at one end thereof along a longitudinal axis thereof, providing a plurality of parallel longitudinally-extending grooves along the longitudinally-extending axis, the plurality of parallel longitudinally-extending grooves abutting the strain-relief area, providing a first transversely-extending trench across the substrate, and providing a second trench extending transversely across the substrate at a location remote from the first trench and adjacent an end of the substrate which is remote from the first trench.

The next step involves, providing a top plate in the form of a base substrate of a suitable material, providing a longitudinally-extending strain-relief area at one end thereof along a longitudinal axis thereof, providing a plurality of parallel longitudinally-extending grooves along said longitudinally-extending axis, the plurality of parallel longitudinally-extending grooves abutting said strain-relief area, providing a first transversely-extending trench across said substrate, and providing a second trench extending transversely across the substrate at a location remote from said first trench and adjacent an end of the substrate which is remote from the first trench.

The next step includes disposing an array of optical fibers within the strain-relief area of either the bottom plate or the top plate and disposing a plurality of bare optical fibers within the plurality of parallel, longitudinally-extending grooves of either the bottom plate or the top plate.

The final step includes preparing a precursor sandwich by superposing the top plate over the bottom plate with the array of optical fibers therebetween in the strain-relief areas and with the plurality of parallel bare exposed optical fibers in the plurality of parallel grooves, and with a minor section of the top plate and the bottom plate of the precursor sandwich being glued together.

The present invention also provides a method for the production of a waveguide. The method includes the steps of providing a waveguide substrate, the waveguide substrate having two opposed lateral ends, each lateral end including a plurality of parallel longitudinal grooves therein and a central region abutting the lateral ends, the central region including a plurality of optical-fiber-coupling structures which abut the plurality of parallel longitudinal grooves. Two half-sandwiches as described hereabove are provided.

An associated half-sandwich is secured to an associated lateral end of the waveguide substrate, with the exposed optical fibers within the plurality of parallel grooves of the waveguide substrate, and also in contact with the optical fiber coupling structures.

The present invention also provides a method for the production of a waveguide. The method includes providing a waveguide substrate, the waveguide substrate having two opposed lateral ends, each lateral end including a plurality of parallel longitudinal grooves therein, and a central region abutting the lateral ends, the central region including a plurality of optical-fiber-coupling structures which abut the plurality of parallel longitudinal grooves. Two full sandwiches as described hereabove are provided.

An associated full sandwich is secured to an associated lateral end of the waveguide substrate, with the exposed optical fibers within the plurality of parallel grooves of the waveguide substrate, and also in contact with the optical fiber coupling structures.

The present invention also provides a substrate for supporting at least one optical fiber. The substrate includes a base substrate of a suitable material. A longitudinally-extending strain-relief area is provided at one end thereof along a longitudinal axis thereof At least one longitudinally-extending groove is provided along said longitudinally-extending axis, the at least one longitudinally-extending groove abutting the strain-relief area. At least a first transversely-extending trench across the substrate.

The present invention also provides a substrate for supporting a plurality of optical fibers. The substrate includes a base substrate of a suitable material. A longitudinally-extending strain-relief area is provided at one end thereof along a longitudinal axis thereof. A plurality of parallel, longitudinally-extending grooves is provided along the longitudinally-extending axis, the plurality of parallel, longitudinally-extending grooves abutting the strain-relief area. At least a first transversely-extending trench is provided across said substrate.

The present invention also provides a precursor sandwich which supports at least one optical fiber. The precursor sandwich includes a bottom plate in the form of a base substrate of a suitable material, a longitudinally extending strain-relief area at one end thereof along a longitudinal axis thereof, at least one longitudinally-extending groove along the longitudinally-extending axis, the at least one longitudinally-extending groove abutting the strain-relief area, and at least a first transversely-extending trench across the substrate.

The precursor sandwich also includes a top plate in the form of a base substrate of a suitable material, a longitudinally-extending strain-relief area at one end thereof along a longitudinal axis thereof, at least one longitudinally-extending groove along the longitudinally-extending axis, the at least one longitudinally-extending groove abutting the strain-relief area, and at least a first transversely-extending trench across the substrate.

The precursor sandwich also includes at least one optical fiber within the strain-relief area of either the bottom plate or the top plate, and at least one bare exposed optical fiber within the at least one longitudinally-extending groove in either the bottom plate or the top plate.

In this way, the precursor sandwich comprises the top plate which is superposed over the bottom plate, with the at least one optical fiber therebetween in the strain-relief area, and with the at least one bare exposed optical fiber in the at least one longitudinally-extending groove, and further in which a minor section of the top plate and the bottom plate of the precursor sandwich have been glued together.

The present invention also provides a precursor sandwich supports a plurality of parallel optical fibers. The precursor sandwich includes a bottom plate in the form of a base substrate of a suitable material, a longitudinally-extending strain-relief area at one end thereof along a longitudinal axis thereof, a plurality of parallel, longitudinally-extending grooves along the longitudinally-extending axis, the plurality of parallel, longitudinally-extending grooves abutting the strain-relief area, and at least a first transversely-extending trench across the substrate.

The precursor sandwich also includes a top plate in the form of a base substrate of a suitable material, a longitudinally-extending strain-relief area at one end thereof along a longitudinal axis thereof, a plurality of parallel, longitudinally-extending grooves along said longitudinally-extending axis, the plurality of parallel, longitudinally-extending grooves abutting said strain-relief area, and at least a first transversely-extending trench across said substrate.

The precursor sandwich also includes an array of optical fibers within the strain-relief area of either the bottom plate or the top plate, and a plurality of parallel, bare exposed optical fibers within the plurality of parallel, longitudinally-extending grooves in either the bottom plate or the top plate.

In this way, the precursor sandwich comprises the top plate which is superposed over the bottom plate, with the array of optical fibers therebetween in the strain-relief area, and with the plurality of parallel, exposed optical fibers in the plurality of parallel, longitudinally-extending grooves, and further in which a minor section of the top plate and the bottom plate of the precursor sandwich have been glued together.

The present invention also provides a precursor sandwich supports at least one optical fiber. The precursor sandwich includes a bottom plate in the form of a base substrate of a suitable material, a longitudinally-extending strain-relief area at one end thereof along a longitudinal axis thereof, at least one longitudinally-extending groove along the longitudinally-extending axis, the at least one longitudinally-extending groove abutting the strain-relief area, a first transversely-extending trench across the substrate, and a second transversely-extending trench across the substrate and adjacent an end of the substrate which is remote from the first trench.

The precursor sandwich also includes a top plate in the form of a base substrate of a suitable material, a longitudinally-extending strain-relief area at one end thereof along a longitudinal axis thereof, at least one longitudinally-extending groove along the longitudinally-extending axis, the at least one longitudinally-extending groove abutting the strain-relief area, a first transversely-extending trench across the substrate and a second transversely-extending trench across the substrate and adjacent an end of the substrate which is remote from the first trench.

The precursor sandwich also includes at least one optical fiber within the strain-relief area of either the bottom plate or the top plate, and at least one bare exposed optical fiber within the at least one longitudinally-extending groove in either the bottom plate or the top plate.

In this way, the precursor sandwich comprises the top plate which is superposed over the bottom plate, with the at least one optical fiber therebetween in the strain-relief area, and with the at least one bare exposed optical fiber in the at least one longitudinally-extending groove, and further in which a minor section of the top plate and the bottom plate of the precursor sandwich has been glued together.

The present invention also provides a precursor sandwich which supports a plurality of parallel optical fibers. The precursor sandwich includes a bottom plate in the form of a base substrate of a suitable material, a longitudinally-extending strain-relief area at one end thereof along a longitudinal axis thereof a plurality of parallel, longitudinally-extending grooves along the longitudinally-extending axis, the plurality of parallel, longitudinally-extending grooves abutting the strain-relief area, a first transversely-extending trench across the substrate and a second transversely-extending trench across the substrate and adjacent an end of the substrate which is remote from the first trench.

The precursor sandwich also includes a top plate in the form of a base substrate of a suitable material, a longitudinally-extending strain-relief area at one end thereof along a longitudinal axis thereof, a plurality of parallel, longitudinally-extending grooves along the longitudinally-extending axis, the plurality of parallel, longitudinally-extending groove abutting the strain-relief area, a first transversely-extending trench across the substrate, and a second transversely-extending trench across the substrate and adjacent an end of the substrate which is remote from the first trench.

The precursor sandwich also includes an array of optical fibers within the strain-relief area of either the bottom plate or the top plate, and a plurality of parallel, bare exposed optical fibers within the plurality of parallel, longitudinally-extending grooves in either the bottom plate or the top plate.

In this way, the precursor sandwich comprises the top plate which is superposed over the bottom plate, with the array of optical fibers therebetween in the strain-relief area, and with the plurality of parallel, exposed optical fibers in the plurality of parallel, longitudinally-extending grooves, further in which a minor section of the top plate and the bottom plate of the precursor sandwich have been glued together.

The present invention also provides a half-sandwich comprising the precursor sandwich as described above, in which the bottom plate has been broken away along the first trench thereof, in which a major unglued portion of the bottom plate has been removed. Thus the half-sandwich includes the optical fiber array and at least one bare exposed optical fiber which is within the at least one groove, or the plurality of parallel exposed optical fibers are within the plurality of parallel grooves, the at least one bare exposed optical fiber, or the plurality of parallel exposed optical fibers depending from a face of the top plate and along the longitudinal axis of the half-sandwich.

The present invention also provides a full sandwich comprising the half-sandwich as described above, in which the top plate has been broken away along the first trench thereof, in which a major unglued portion of the top plate has been removed.

Thus, the full sandwich includes the optical fiber array and at least one bare exposed optical fiber which is cantelevered from the remaining minor portion of the top plate and the bottom plate, or the plurality of parallel exposed optical fibers which are cantelevered from the remaining minor portion of the top plate and the bottom plate and along the longitudinal axis of the fill sandwich.

The present invention also provides a waveguide comprising a waveguide substrate having two opposed lateral ends, each lateral end including a plurality of parallel longitudinal grooves therein, and a central region abutting both the lateral ends, the central region including a plurality of parallel optical-fiber-coupling structures which abut the plurality of parallel grooves.

The waveguide also includes associated half-sandwich as described above which is secured to an associated lateral end of the waveguide substrate, with the plurality of parallel exposed optical fibers within the plurality of parallel grooves in the lateral ends of the waveguide substrate, and also in contact with the plurality of parallel optical-fiber-coupling structures.

The present invention also provides a waveguide comprising a waveguide substrate having two opposed lateral ends, each lateral end including a plurality of parallel longitudinal grooves therein, and a central region abutting both lateral ends, the central region including a plurality of parallel optical-fiber-coupling structures which abut the plurality of parallel grooves.

The waveguide also includes an associated full sandwich as described above which is secured to an associated lateral end of the waveguide substrate, with the plurality of parallel exposed optical fibers within the plurality of parallel grooves in the lateral ends of the waveguide substrate, and also in contact with the plurality of parallel optical-fiber-coupling structures.

### Other Features of the Invention

A first feature of the method of this invention is where the strain-relief area extends longitudinally on both lateral sides of the first trench.

A second feature of the methods of this invention is where the strain-relief area extends longitudinally from said first trench only to said one edge thereof.

A third feature of the method of this invention is where the strain-relief area extends longitudinally from said one edge thereof to stop short of said strain-relief area.

A fourth feature of the methods of this invention is one which includes providing a second trench extending transversely across the substrate at a location remote from the first trench and adjacent an end of the substrate which is remote from the first trench.

A fifth feature of the methods of this invention is where the at least one optical fiber, or the array of optical fibers, and the at least one bare exposed optical fiber or the plurality of parallel bare exposed optical fibers is disposed at an angle beta to the central longitudinal axis of the precursor sandwich.

A sixth feature of the methods of this invention is one which include the step of breaking the bottom plate of the precursor sandwich along the first trench, and removing a major unglued section of the bottom plate, thereby providing a half-sandwich including the at least one bare exposed optical fiber or the plurality of parallel bare exposed optical fibers, both within the at least one groove or within the plurality of parallel grooves and depending from a face of the top plate.

A seventh feature of the methods of this invention is one which includes the additional steps of cutting the precursor sandwich adjacent an edge which is remote from the first trench, and breaking away a portion of the top plate thereby exposing an end of the at least one bare exposed optical fiber or the ends of the plurality of parallel bare exposed optical fibers and polishing the exposed end or ends of the optical fiber or fibers.

An eight feature of the methods of this invention is one where the cut is tilted at an angle gamma to the vertical.

A ninth feature of the methods of this invention is one where the cut is completely through the top plate but only partly through the lower plate.

A tenth feature of the methods of this invention is where the cut is disposed at an angle delta to the longitudinal axis of said precursor sandwich.

An eleventh feature of the methods of this invention is where the said bare exposed optical fiber or said plurality of parallel bare exposed optical fibers are disposed at an angle theta to the longitudinal axis of the said precursor sandwich.

A twelfth feature of the methods of this invention is where the additional steps of breaking the top plate the half-sandwich along the first trench of the top plate, and removing a major unglued section of the top plate thereby providing a fall sandwich including a bare exposed cantelevered optical fiber or plurality of parallel bare exposed cantelevered optical fibers, which extend along the longitudinal axis of said full sandwich.

A thirteenth feature of this invention provides a substrate in which the strain-relief area extends longitudinally on both lateral sides of the first trench.

A fourteenth feature of this invention provides a substrate in which the strain-relief area extends longitudinally from the first trench only to that one end thereof.

A fifteenth feature of this invention provides a substrate in which the strain-relief area extends longitudinally from said one end thereof to stop short of the first trench.

A sixteenth feature of this invention provides a substrate in which includes a second transversely-extending trench across the substrate at a location remote from the first trench and adjacent an end of the substrate which is remote from the first trench.

A seventeenth feature of this invention provides a precursor sandwich in which the said strain-relief area extends longitudinally on both lateral sides of the first trench.

An eighteenth feature of this invention provides a precursor sandwich in which the strain-relief area extends longitudinally from the first trench only to that one end thereof.

A nineteenth feature of this invention provides a precursor sandwich in which the said strain-relief area extends longitudinally from said one end thereof to stop short of said first trench.

A twentieth feature of this invention provides a precursor sandwich in which the at least one optical fiber or the array of optical fibers, and the at least one bare exposed optical fiber or the plurality of parallel bare exposed optical fibers, is or are, disposed at an angle beta to the central longitudinal axis of the precursor sandwich.

A twenty-first feature of this invention provides a precursor sandwich in which the precursor sandwich has been cut adjacent an end which is remote from the first trench, and in which a portion of the top plate has been broken away thereby providing an exposed end of an optical fiber or exposed ends of the optical fibers, which preferably have been polished.

A twenty-second feature of this invention provides a precursor sandwich in which the cut is tilted at an angle gamma to the vertical.

A twenty-hird feature of this invention provides a precursor sandwich in which the cut is in the form of a cut which has been cut completely through the top plate but only partly through the bottom plate.

A twenty-fourth feature of this invention provides a precursor sandwich in which the cut is disposed at an angle delta to the longitudinal axis of the precursor sandwich.

A twenty-fifth feature of this invention provides a precursor sandwich in which the bare exposed optical fiber or the plurality of parallel exposed optical fibers is, or are, disposed at an angle theta to the longitudinal axis of the precursor sandwich.

### Generalized Description of the Invention

In other words, the invention uses a first, bottom silicon substrate to hold the fibers in accurate alignment. The first substrate has parallel V-grooves into which fibers can be placed with precise alignment, a rectangular excavation (strain relief area) which is large enough to hold the fiber buffer that typically protects fiber arrays, and a trench that is used to form an epoxy dam as well as the break line for removing a part of the substrate, thus exposing a portion of the fibers. The trench in the plate serves as a stress concentrator and ensures that the plate will break at the desired location when pressure is applied to the free end of the plate.

A second, top silicon plate with matching V-grooves and strain relief area is placed onto the bottom substrate forming a fiber sandwich. The top silicon plate may also have trenches for breaking away a part of the top plate and further exposing the fibers.

The top and bottom plates of the sandwich are secured together with epoxy forming a single unit that is holding the fibers firmly in place for preparation. The epoxy is confined to two areas of the sandwich; one area is behind the trench at the strain relief end of the sandwich; and the other area is at the end of the sandwich opposite the strain relief area,

The end of the sandwich opposite the strain relief are may now be cut off at any predetermined angle and length, and the exposed fiber ends polished if required.

To expose the bottom half of the fibers, the bottom plate may be broken away at the trench. To completely expose a length of fibers, both the top and bottom plates may be broken away at the trenches.

The resulting package is an accurately prepared fiber array with the ability to expose any pre-determined length of fibers. In addition, the sections of the silicon plates attached at the strain relief area serve as a handling platform for automated or manual manipulation of the fiber array. Standard manufacturing techniques such as alignment fiducials could be used to assist the manipulation process.

The break-away sandwich invention disclosed herein has numerous advantages over previous inventions. It provides a reliable holding mechanism for the fibers that allows the fibers to be aligned, cut, angled and polished with high precision. It provides a simple means for exposing any reasonable length of the fibers, as well as optionally exposing only the top or bottom halves of the fibers. In addition, the invention provides a handling means that both protects the fibers, and facilitates low cost manufacturing of optical components utilizing the invention.

### BRIEF DESCRIPTION OF THE DRAWINGS

The present invention will now be described in detail in conjunction with annexed drawings FIGS. 1 to 28 illustrating steps in the methods of embodiments of the invention and devices of embodiments of the invention, in which:

FIG. 1 is an isometric view of a silicon substrate for the production of a package for an accurately prepared fiber array of one embodiment of this invention;

FIG. 2 is an isometric view of a bottom plate comprising the silicon substrate of FIG. 1 and a fiber buffer and a fiber array of a second embodiment of this invention;

FIG. 3 is an isometric view of a silicon substrate for the production of a package for an accurately prepared fiber array of a third embodiment of this invention;

FIG. 4 is an isometric view of a bottom plate comprising the silicon substrate of FIG. 3 and a fiber buffer and a fiber array of a fourth embodiment of this invention;

FIG. 5 is an isometric view of a silicon substrate for the production of a package for an accurately prepared fiber array of a fifth embodiment of this invention;

FIG. 6 is an isometric view of a bottom plate comprising the silicon substrate of FIG. 1 and fiber buffer and a fiber array of a sixth embodiment of this invention;

FIG. 7 is an isometric view of a silicon substrate upper plate as shown in FIG. 1 and a bottom silicon plate as shown in FIG. 2 in side-by side relationship before begin mated into a fiber sandwich;

FIG. 8 is an isometric intermediate view of the silicon substrate upper plate as shown in FIG. 7 being mated with the bottom silicon plate as shown in FIG. 7 in the formation into a fiber sandwich;

FIG. 9 is an isometric view of the fiber sandwich according to another embodiment of this invention which has been formed as shown in FIG. 8

FIG. 10 is an isometric view of the fiber sandwich according to another embodiment of this invention which has been formed as shown in FIG. 8, but where the end face has been completely cut through;

FIG. 11 is a side elevational view of the fiber sandwich shown in FIG. 10;

FIG. 12 is an isometric view of a fiber half sandwich shown in FIG. 10, but in another embodiment after the bottom silicon plate has been broken away;

FIG. 13 is a side elevational view of the fiber half sandwich shown in FIG. 12, but in another embodiment also showing the trench;

FIG. 14 is an isometric view, looking from the bottom, of a fiber half sandwich according to the embodiment of the invention shown in FIG. 12;

FIG. 15 is an isometric view of a fiber full sandwich according to another embodiment of this invention but also showing the fibers being fully exposed after breaking away of the silicon substrate upper plate and the bottom silicon plate;

FIG. 16 is an isometric view of a fiber full sandwich of FIG. 15, but in another embodiment also showing and extended fiber buffer;

FIG. 17 is an isometric view of an intermediate stage in the production of an improved waveguide device according to another embodiment of this invention including the fiber half sandwich of FIG. 12;

FIG. 18 is an isometric view of an improved waveguide device according to another embodiment of this invention, including the fiber half sandwich of FIG. 12 which has been made according the depiction of FIG. 17;

FIG. 19 is an isometric exposed view of the central section of the improved waveguide device according to the invention as shown in FIG. 18, and also showing the improved waveguide;

FIG. 20 is an isometric view of an intermediate stage in the production of an improved waveguide device according to another embodiment of this invention including the fiber full sandwich of FIG. 15;

FIG. 21 is an isometric view of an improved waveguide device according to another embodiment of this invention including fiber fill sandwich of FIG. 15 which has been made according to the depiction of FIG. 20;

FIG. 22 is a side elevational view of the improved waveguide as shown in FIG. 21;

FIG. 23 is an isometric view of a fiber full sandwich of another embodiment of this invention, but also showing the partial cut-through embodiment;

FIG. 24 is an isometric view of a fiber full sandwich, or of a fiber half sandwich, of other embodiments of this invention, to illustrate the formation of the fiber sandwich with a partial angular cut;

FIG. 25 is an isometric view of a fiber full sandwich, or of a fiber half sandwich, of other embodiments of this invention, to illustrate the formation of the fiber sandwich with a fill angular cut;

FIG. 26 is an isometric view, looking from the bottom, of another embodiment of the invention having a second trench;

FIG. 27 is an isometric view, looking from the bottom, of the embodiment of the invention shown in FIG. 26, with the bottom silicon substrate broken away; and

FIG. 28 is an isometric view, looking from the bottom, of the embodiment of the invention shown in FIG. 26, with the bottom silicon substrate broken away; and with the top plate partially broken away.

### DESCRIPTION OF PREFERRED EMBODIMENTS

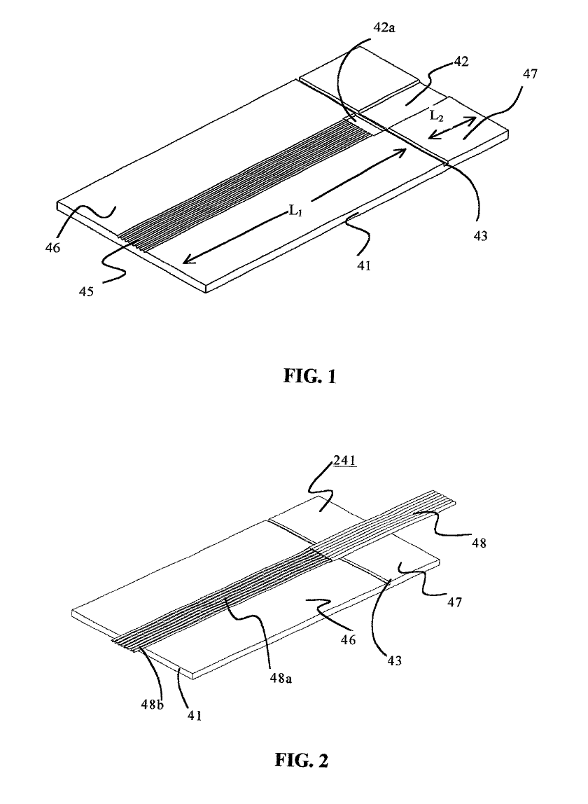

As shown in FIG. 1, one embodiment of a silicon substrate for the production of a package for an accurately prepared fiber array comprises a bottom silicon substrate 41 which is provided with an inset strain relief area 42 and with a plurality of parallel V-grooves 45. The bottom silicon substrate is divided into two sections by a transverse trench 43. The two sections are a major, or upper, substrate section 46 and a minor, or lower, substrate section 47.

FIG. 1 also shows that the strain relief area extends in the lower substrate section 47, but also extends beyond the trench 43 into the upper substrate section 46 as strain relief area 42a.

The silicon substrate may be etched, laser milled, machined or otherwise processed to produce the bottom silicon substrate 41, as shown in this embodiment in FIG. 1. Etching is one well-known method for producing V-grooves in silicon with accuracy better than plus/minus 0.5 micrometer or micron (μm).

The dimensions of the V-grooves 45 and strain relief area 42 depend upon the number of fibers, fiber size and fiber buffer dimensions, but for typical single mode fiber arrays the following numbers are provided as examples.

The strain relief area 42 is deep and wide enough to accept 250-μm diameter fiber buffer, approximately 130 μm deep.

The trench 43 is approximately 125 μm wide and 150 μm deep, as it needs to be deeper than the strain relief area in order to serve as a dam for a suitable adhesive, e.g. an epoxy, as well as the break line.

The V-grooves 45 for holding 125 μm diameter fibers would be 250 μm center-to-center, sized to control the fiber axis height required to generate the desired gap between the top and bottom plates.

Length L₁ is typically 15 mm and length L₂ is typically 5 mm, although both lengths can be easily changed.

As seen in FIG. 2 shows the preparation of the bottom plate 241 by placing a fiber array 48 in the bottom of the strain relief areas 42 and 42a. Bare fibers 48a are disposed in the V-grooves 45. Bare fibers 48b overhang the edge 41a of the bottom silicon substrate 41.

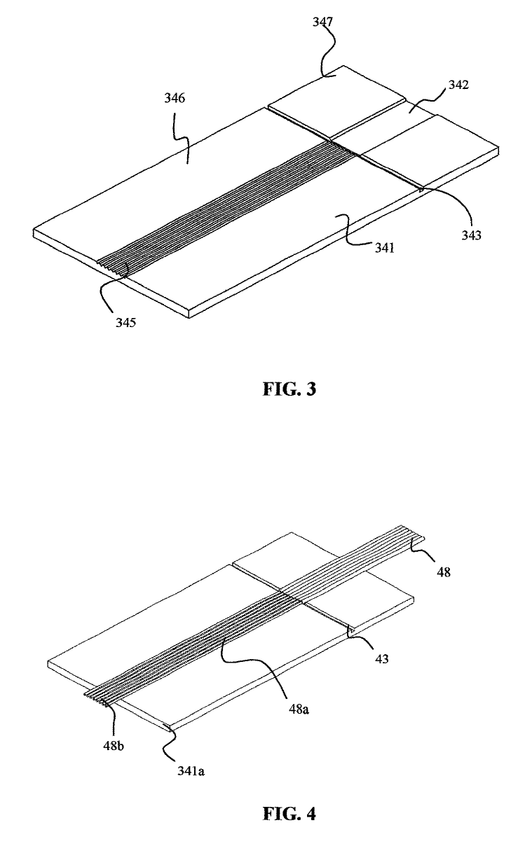

As shown in FIG. 3, another embodiment of a silicon substrate for the production of a package for an accurately prepared fiber array comprises a bottom silicon substrate 341 which is provided with an inset strain relief area 342 and with a plurality of parallel V-grooves 345. The bottom silicon substrate 341 is divided into two sections by a transverse trench 343. The two sections are a major, or upper, substrate section 346 and a minor, or lower, substrate section 347.

FIG. 3 also shows that the strain relief area extends in the lower substrate section 47, which terminates at the trench 343.

As seen in FIG. 4, a fiber array 48 is placed in the bottom of the strain relief area 342. Bare fibers 48a area disposed in the V-grooves 345. Bare fibers 48b overhang the edge 341a of the bottom silicon substrate 341.

As shown in FIG. 5, another embodiment of a silicon substrate for the production of a package for an accurately prepared fiber array comprises a bottom silicon substrate 541 which is provided with an inset strain relief area 542 and with a plurality of parallel V-grooves 545. The bottom silicon substrate is divided into two sections by a transverse trench 543. The two sections are a major, or upper substrate section 546 and minor, or lower, substrate section 547.

FIG. 5 also shows that the parallel V-grooves 545 extend in the upper substrate section 546, but also extend beyond the trench 543 into the lower substrate section 546 as strain relief area 545a.

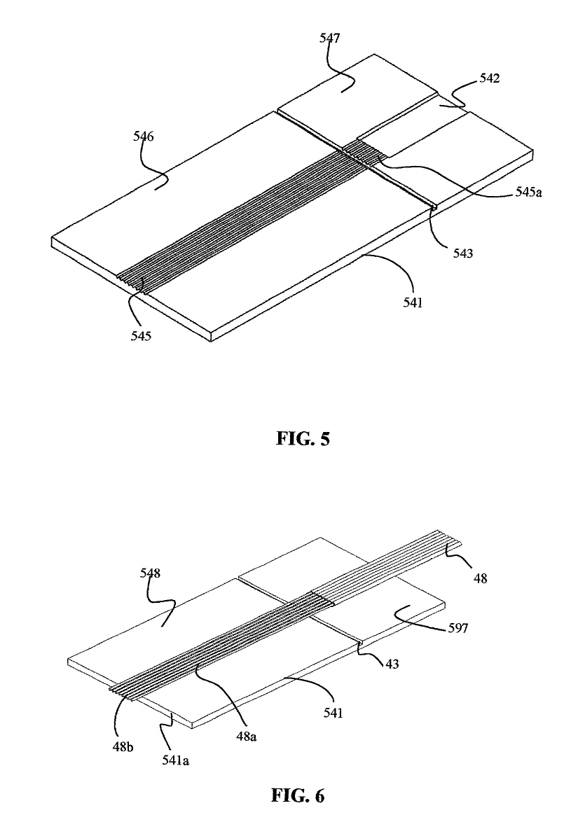

As seen in FIG. 6, a fiber array 48 is placed in the bottom of the strain relief area 542. Bare fibers 48a area disposed in the V-grooves 545 and V-grooves 545a. Bare fibers 48b overhang the edge 541a of the bottom silicon substrate 541. The fiber array 48 could also be a number of individual fibers.

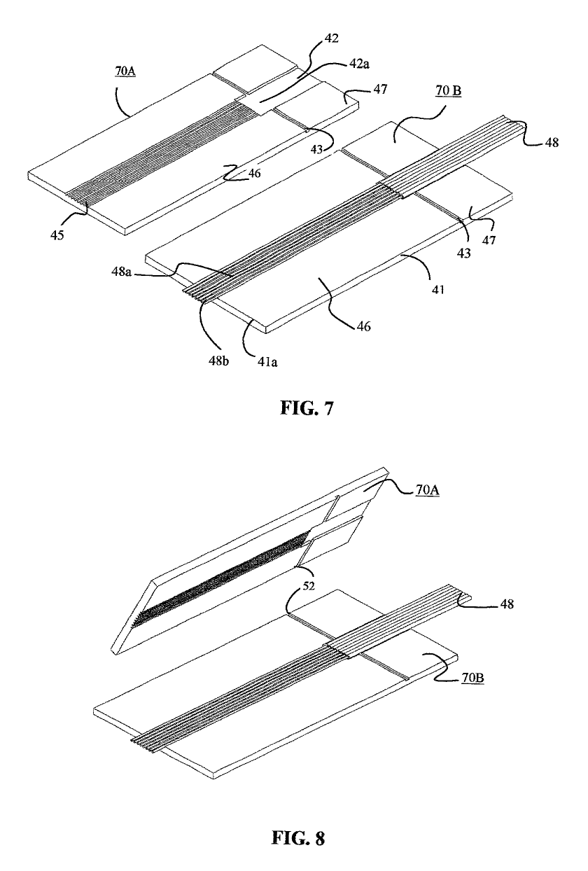

FIG. 7 shows the bottom plate of FIG. 2 in a side-by-side relationship with the upper silicon substrate of FIG. 1. In this FIG, the upper silicon substrate is identified by the generic reference number 70A and the lower plate is identified by the generic reference number 70B.

Thus, it is seen that upper silicon substrate 70A includes (as previously described) bottom silicon substrate 41 which is provided with an inset relief area 42 and with a plurality of parallel V-groove 45. The bottom silicon substrate 41 is divided into two sections by a transverse trench 43. These two sections area a major, or upper, section 46, and a minor, or lower section 47. The strain relief area 42 extends in the lower substrate section 47 and also extends beyond the trench 43 into the upper substrate section 46 as strain relief section 42a.

It is also seen that the bottom plate 70B includes a fiber array 48 which is placed in the bottom of the strain relief areas 42 and 42a. Bare fibers 48a are disposed in the V-grooves 45. In addition, bare fibers 48b overhang the edge 41a of the bottom silicon substrate 41.

As seen in FIG. 8, the upper silicon substrate 70A is placed atop the bottom plate 70B so that the V-grooves 45 align with the bare fibers 48a, so that the fiber array aligns with the strain relief area 42 and so that the trenches 43 area substantially aligned.

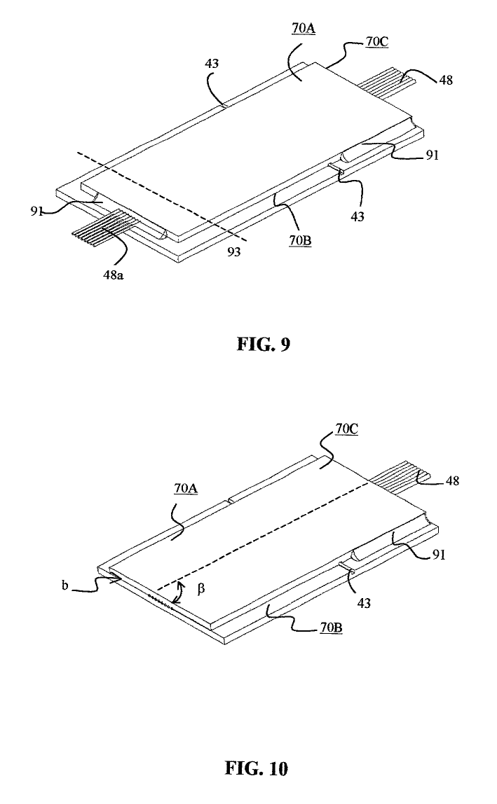

As seen in FIG. 9, extremely thick non-wicking adhesive, e.g., epoxy 91, is used to bond the edges of the upper silicon substrate 70A to the upper face of the bottom plate 70B, to form a sandwich 70C of an embodiment of this invention.

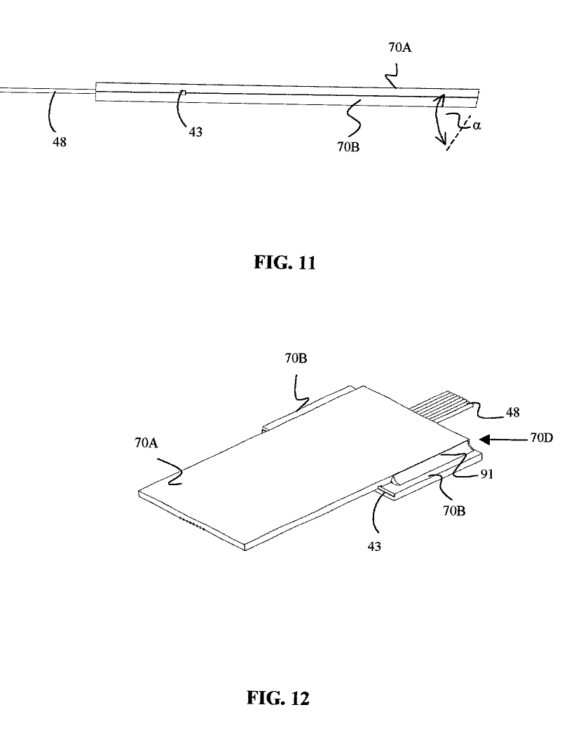

FIGS. 9,10 and 11 show the production of fiber sandwich of an embodiment of this invention where only the bottom half of the bare fibers 48a are exposed. As shown in FIG. 9, the sandwich 70 C is cut completely through along the line 93. The angle alpha (see FIG. 11) depends on the specific requirements. For example, it could be in the range of 90 degrees or in the range of 80 to 85 degrees or in the range of 95 to 100 degrees. The angle beta (see FIG. 10) is preferably 90 degrees to the axis of the fibers.

At this point, the upper silicon substrate 70A and the bottom plate 70B may be temporality be clamped together, and the severed ends of the bare fibers may be polished.

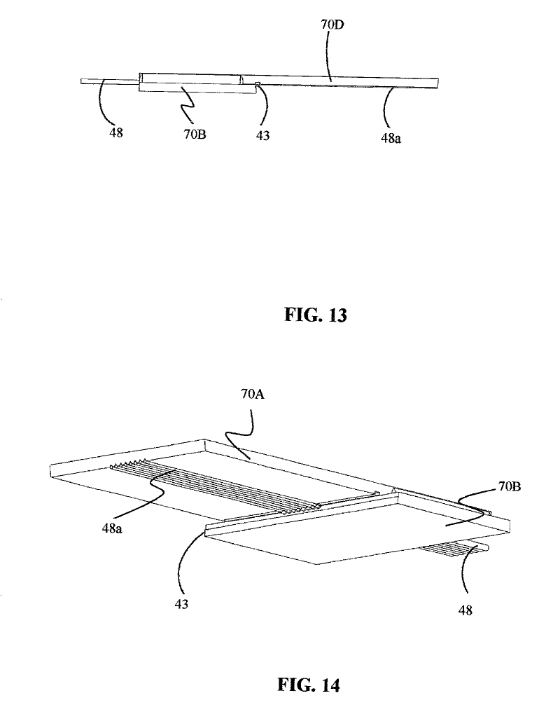

The next stage in the manufacturing procedure is the formation of the half-sandwich of an embodiment of this invention. This is shown in FIG.12, FIG. 13 and FIG. 14.

As seen in these FIGS, the major section 46 (see FIG. 1) of the bottom plate 70B is broken away at trench 43. This forms half-sandwich 70D, which consists of major section 46 of bottom plate 70B, fiber array 48 and exposed bare fibers 48a.

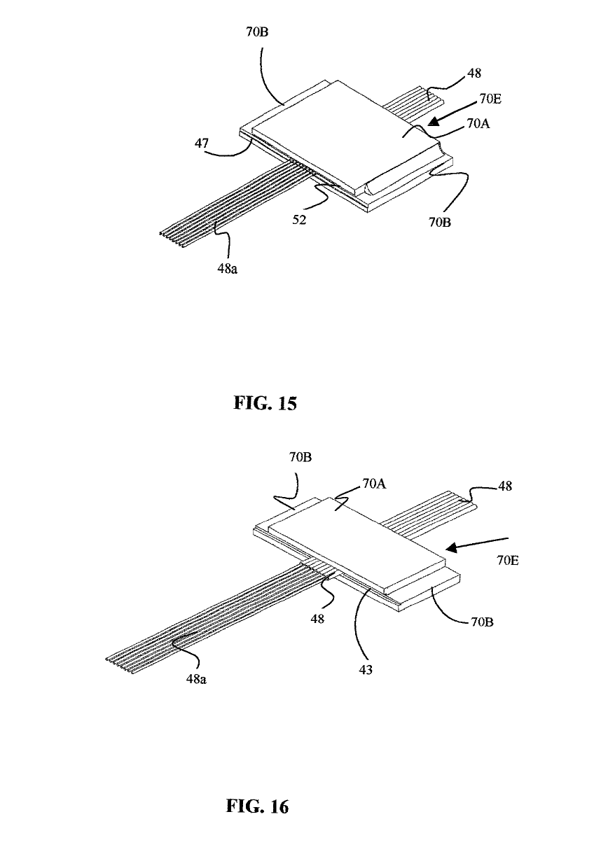

The next stage in the manufacturing procedure is the formation of the full sandwich of an embodiment of this invention. This is shown in FIG. 15 and FIG. 16.

As seen in these FIGS, the major section 46 (see FIG.1) of the half-sandwich 70D is broken away at trench 43. This forms full sandwich 70E, which consists of minor section 47 (see FIG. 1) of upper silicon substrate 70A, fiber array 48 and exposed bare fibers 48a.

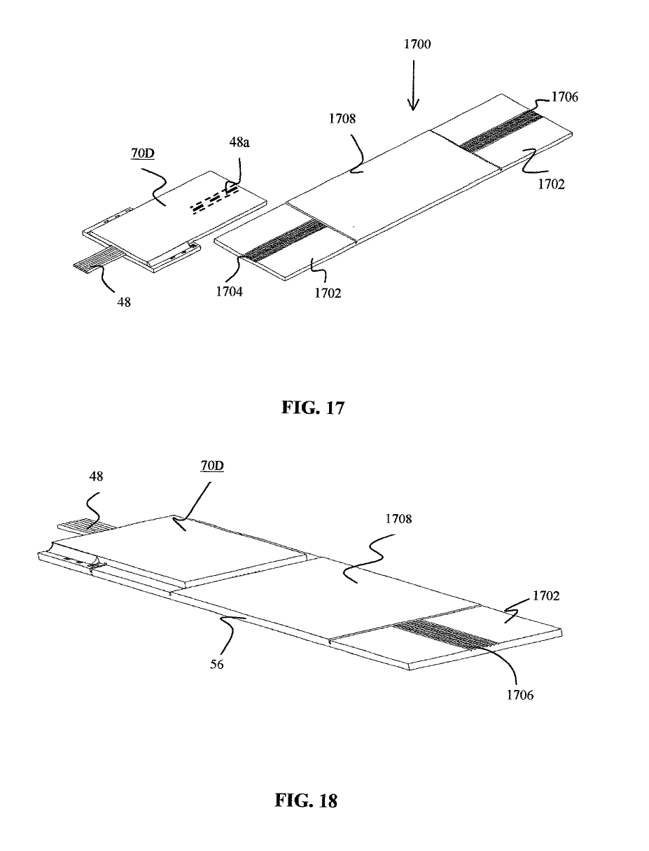

Another embodiment of the invention is shown in FIG. 17, FIG. 18 and FIG. 19. In these FIGS, a waveguide according to an embodiment of the invention is produced.

As seen in these FIGS, the waveguide 1700 consists of a suitable substrate 1702 within which are a plurality of lateral, fiber-mating areas, 1704 1706, which may be V-grooves or other aligning structures. Two half-sandwiches 70D (only one of which is shown) are superposed atop the fiber-mating areas 1704, 1706, so that the exposed fibers 48a mate within the fiber-mating areas 1704, 1706.

FIG. 19 shows the central area 1708 of the waveguide 1700. That central section 1708 comprises the suitable substrate 1702 which is provided with a transverse trench 1710. The suitable substrate is also provided with a plurality of longitudinal, conventional fibers 1714, to which the bare exposed fibers 48a (in FIG. 18) of the half-sandwich are to be coupled.

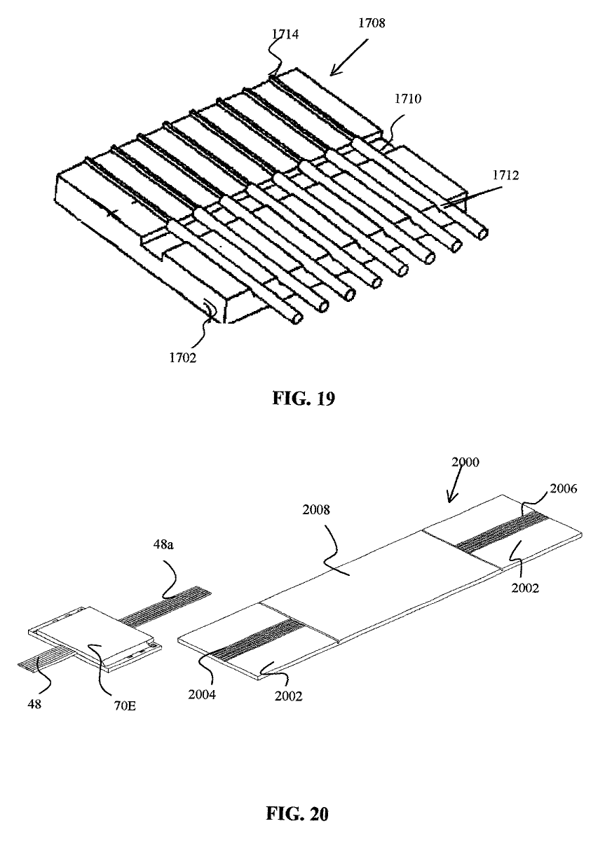

Another embodiment of the invention is shown in FIG. 20. In this FIG, a waveguide according to an embodiment of the invention is produced.

As seen in this FIG, the waveguide 2000 consists of a suitable substrate 2002 within which are plurality of longitudinal fiber-mating areas, 2004 2006, which may be V-grooves or other aligning structures. Two full sandwiches 70E (only one of which is shown) are superposed atop the fiber-mating areas 2004, 2006, so that the exposed fibers 48a mate within the fiber-mating areas 1704, 1706.

The central area 2008 of the waveguide 2000 is identical to the central area 170 shown in FIG. 19, and so will not be described further.

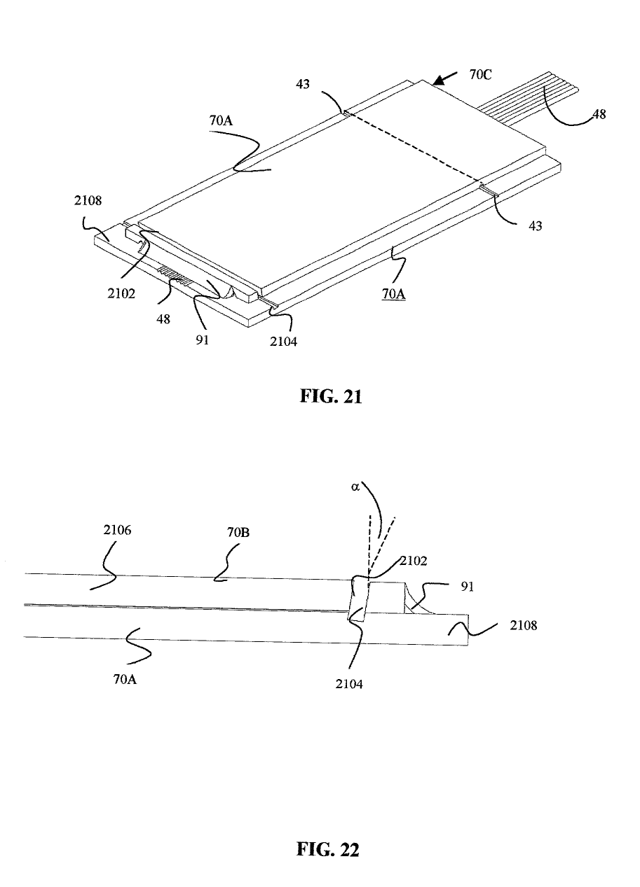

Another embodiment of the invention is shown in FIG. 21 and FIG. 22, and starts with the sandwich shown in FIG. 9.

In this embodiment, the cut 2102 is made to cut completely through the bare exposed fibers 48a, but only to cut a trench 2104 in the bottom plate 70A. The cut 2102 is tilted at an angle gamma to the vertical, as shown in FIG. 22. Then, the unglued portion 2106 of the upper silicon plate 70A is broken away at the trench 43, to provide full sandwich (not seen). This sandwich contains the exposed portion of the bottom plate 70A, and the minor section 47 of the upper silicon plate 70B, as well as silicon substrate remnant 2108.

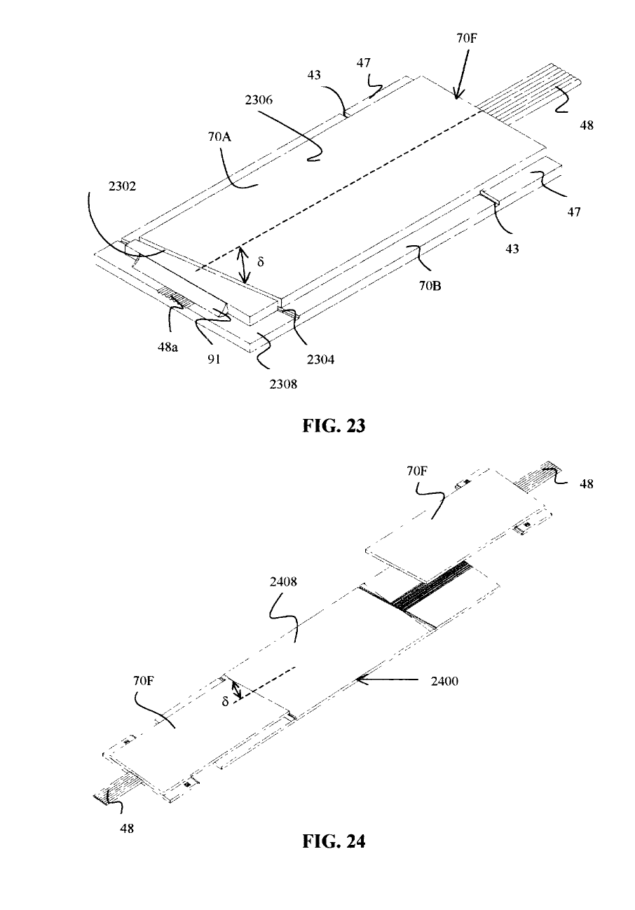

Another embodiment of the invention is shown in FIG. 23 and the use thereof to provide another embodiment of a waveguide is shown in FIG. 24. These embodiments of the invention start with the sandwich shown in FIG. 9.

In the embodiment shown in FIG. 23, the partial cut 2302 is made to cut completely through the bare exposed fibers 48a, but only to cut a trench 2304 in the bottom plate 70A. The cut 2302 is cut at an angle delta to the central longitudinal axis of the sandwich 70C. The cut 2302 may be a completely vertical cut, or, as described in FIG. 22, may be tiled at an angle gamma to the vertical, as shown in FIG. 22. Then, the unglued portion 2308 of the lower silicon plate 70B is broken away at the trench 43, to provide a half sandwich (not seen in this figure but seen in FIG. 24). This sandwich contains the exposed portion of the upper plate 70A, and the minor section 47 of the bottom silicon plate 70B, as well as a silicon substrate remnant 2308.

FIG. 24 shows the production of a waveguide of an embodiment of the invention which is similar in most respects to the production of the embodiment of the waveguide shown in FIG. 17, FIG. 18 and FIG. 19. The only difference is that the abutting edges of the fill sandwich 70F and the central portion 48 of the waveguide 2400 must be cut at the same angle.

Another embodiment of the invention is shown in FIG. 25 and starts with the sandwich shown in FIG. 9.

In this embodiment, the cut 2502 is made to cut completely through both bare exposed fibers 48a, and the bottom plate 70A, leaving the ends of the bare exposed fibers 48a visible at the cut edges 41a and 48a. The cut shown in broken lines at 2502 is vertical, but is disposed at an angle of theta to the central longitudinal axis of the upper silicon substrate 70A. The remaining steps of producing the sandwiches shown in FIGS. 12 to 16 are the same as previously described.

The use of the embodiment of FIG. 25 to make a waveguide of an embodiment of this invention is similar to the production of the embodiment of the waveguide shown in FIG. 24. The only difference is that the sandwich is different. However, the abutting edges of the sandwich and the central portion of the waveguide must be cut at the same angle.

Another embodiment of the invention is shown in FIG. 26, FIG. 27 and FIG. 28 and starts with the embodiment of FIG. 7.

In this embodiments, the upper silicon substrate 70A has a second trench 2643 made therein. Then the processing proceeds as shown in FIG. 27 and 28 to form a half-sandwich as previously described in FIGS. 9 to 14. Then the top plate upper silicon substrate 2649 can be broken away, leaving a half-sandwich 70C with a length of bare exposed fibers 48b fully exposed.

It should be obvious to a person skilled in the art that the plates could be fabricated from any material that can be processed within precision tolerances, and that can break cleanly and consistently at a trench. Although it is not as efficient, it would be possible to cut away the plate at the trench using a saw or other such device. It should also be obvious to person skilled in the art that the positioning grooves in the top and bottom plates may take the form of U-grooves, or other like shapes that provide the support and precision required for aligning optical fibers. Further, the fibers could be fixed in the grooves by materials such as wax, easily dissolved adhesives or the like, which would be removed prior to breaking away the plates. In the case of the half-sandwich, the fibers could be fixed to the top late with an adhesive or the like, prior to cutting the fibers and breaking away the bottom plate.

### CONCLUSION

From the foregoing description, one skilled in the art can easily ascertain the essential characteristics of this invention, and without departing from the spirit and scope thereof, can make various changes and modifications of the invention to adapt it to various usages and conditions. Consequently, such changes and modifications are properly, equitably, and “intended” to be, within the full range of equivalence of the following claims.

What is claimed is:

1. A method for preparing a substrate for supporting at least one optical fiber, said method comprising:
providing a base substrate of a suitable material;
providing at least one longitudinally-extending groove along a longitudinally-extending axis of said substrate but less than its full length; and
providing at least a first transversely-extending trench across said substrate near one end thereof, prior to positioning said at least one optical fiber thereon.

2. A method for preparing a substrate for supporting a plurality of optical fibers, said method comprising:
providing a base substrate of a suitable material;
providing a longitudinally-extending, strain relief area at one end thereof along a longitudinal axis thereof,
providing a plurality of parallel longitudinally-extending grooves along said longitudinally-extending axis, said longitudinally-extending grooves abutting said strain-relief area; and
providing at least a first transversely-extending trench across said substrate, prior to positioning the plurality of optical fibers thereon.

3. The method of claim 1 or claim 2, wherein the strain-relief area extends longitudinally on both lateral sides of the first trench.

4. The method of claim 1 or claim 2, wherein the strain-relief area extends longitudinally from said first trench only to said one end thereof.

5. The method of claim 1 or 2, wherein said strain-relief area extends longitudinally from said one end thereof to stop short of said first trench.

6. The method of any one of claims 1 to 5, including a second trench extending transversely across the substrate at a location remote from said first trench and adjacent an end of said substrate which is remote from said first trench.

7. A method for preparing an element which supports at least one optical fiber, said method comprising:
(a) providing a bottom plate in the form of a base substrate of a suitable material providing a longitudinally-extending strain-relief area at one end thereof along a longitudinal axis thereof, providing at least one longitudinally-extending groove along said longitudinaly-extending axis, said at least one longitudinally-extending groove abutting said strain-relief area, and providing at least a first transversely-extending trench across said substrate;
(b) providing a top plate in the form of a base substrate of suitable material, providing a longitudinally-extending strain-relief area at one end thereof along a longitudinally axis thereof, providing at least one longitudinally-extending groove along said longitudinally-extending axis, said at least one longitudinally-extending groove abutting said strain-relief area, and providing at least a first transversely-extending trench across said substrate;
(c) disposing at least one optical fiber within said strain-relief area of either said bottom plate or said top plate and disposing at least one bare optical fiber within said at least one longitudinally-extending groove of either the bottom plate or said top plate; and
(d) preparing a precursor sandwich by superposing the top plate over said bottom plate with said at least one optical fiber therebetween in the strain-relief areas and with said at least one bare exposed optical fiber in said grooves and with a minor section of the top plate and said bottom plate of said precursor sandwich being glued together.

8. A method for preparing an element which supports a plurality of optical fibers, said method comprising:
(a) providing a bottom plate in the form of a base substrate of a suitable material, providing a longitudinally-extending strain-relief area at one end thereof along a longitudinally axis thereof, providing a plurality of parallel, longitudinally-extending grooves along the longitudinally-extending axis, said plurality of parallel longitudinally-extending grooves abutting said strain-relief are, and providing at least a first transversely-extending trench across said substrate;
(b) providing a top plate in the form of a base substrate of a suitable material, providing a longitudinally-extending strain-relief area at one end thereof along a longitudinal axis thereof, providing a plurality of parallel longitudinally-extending grooves along said longitudinally-extending axis, said plurality of parallel longitudinally-extending grooves abutting said strain-relief area, and providing at least a first transversely-extending trench across said substrate;
(c) disposing an array of optical fibers within said strain-relief area of either said bottom plate or said top plate, and disposing a plurality of parallel bare optical fibers within said parallel longitudinally-extending grooves of either said bottom plate or said top plate; and
(d) preparing a precursor sandwich by superposing said top plate over said bottom plate with said array of optical fibers therebetween in said strain-relief areas and with said plurality of parallel bare exposed optical fibers in said grooves, and with a minor section of said top plate and the bottom plate of said precursor sandwich being glued together.

9. A method for preparing an element which supports at least one optical fiber, said method comprising:
(a) providing a bottom plate in the form of a base substrate of a suitable material, providing a longitudinally-extending strain-relief area at one end thereof along a longitudinal axis thereof, providing at least one longitudinally-extending groove along said longitudinally-extending axis, said at least one longitudinally-extending groove abutting said strain-relief area, providing a first transversely-extending trench across said substrate, and providing a second trench extending transversely across said substrate at a location remote from said first trench and adjacent an end of said substrate which is remote from said first trench;
(b) providing a top plate in said form of a base substrate of a suitable material, providing a longitudinally-extending strain-relief area at one end thereof along a longitudinally-extending axis thereof, providing at least one longitudinally-extending groove along said longitudinally-extending axis, said at least one longitudinally-extending groove abutting said strain-relief area, providing a first transversely-extending trench across said substrate, and providing a second trench extending transversely across said substrate at a location remote from said first trench and adjacent an end of said substrate which is remote from said first trench;
(c) disposing at least one optical fiber within said strain-relief area of either said bottom plate or said top plate and disposing at least one bare optical fiber within said at least one longitudinally-extending groove of either said bottom plate or said top plate; and
(d) preparing a precursor sandwich by superposing said top plate over said bottom plate with said at least one optical fiber therebetween in said strain-relief areas and with said at least one bare exposed optical fiber in said grooves, and with a minor section of said top plate and said bottom plate of said precursor sandwich being glued together.

10. A method for preparing an element which supports a plurality of optical fibers, said method comprising:
(a) providing a bottom plate in the form of a base substrate of a suitable material, providing a longitudinally-extending strain-relief area at one end thereof along a longitudinal axis thereof, providing a plurality of parallel longitudinally-extending grooves along said longitudinally-extending axis, said plurality of parallel longitudinally-extending grooves abutting said strain-relief area, providing a first transversely-extending trench across said substrate, and providing a second trench extending transversely across said substrate at a location remote from said first trench and adjacent an end of said substrate which is remote from said first trench;
(b) providing a top plate in the form of a base substrate of a suitable material, providing a longitudinally-extending strain-relief area at one end thereof along a longitudinal axis thereof, providing a plurality of parallel longitudinally-extending grooves along said longitudinally-extending axis, said plurality of parallel longitudinally-extending grooves abutting said strain-relief area, providing a first transversely-extending trench across said substrate, and providing a second trench extending transversely across said substrate at a location remote from said first trench and adjacent an end of said substrate which is remote from said first trench;
(c) disposing an array of optical fibers within the strain-relief area of either the bottom plate or the top plate and disposing a plurality of bare optical fibers within said plurality of parallel, longitudinally-extending grooves of either said bottom plate or said top plate; and
(d) preparing a precursor sandwich by superposing the top plate over said bottom plate with said array of optical fibers therebetween in the strain-relief areas and with said plurality of parallel bare exposed optical fibers in said plurality of parallel grooves, and with a minor section of said top plate and said bottom plate of said precursor sandwich being glued together.

11. The method of any one of claims 1 to 10, wherein the strain-relief area extends longitudinally on both lateral sides of said first trench.

12. The method of any one of claims 1 to 10, wherein said strain-relief area extends longitudinally from said first trench only to said one edge thereof.

13. The method of any one of claims 1 to 10, wherein said strain-relief area extends longitudinally from said one edge thereof to stop short of said strain-relief area.

14. The method of any one of claims 7 to 13, wherein said at least one optical fiber, or said array of optical fibers, and said at least one bare exposed optical fiber or the plurality of parallel bare exposed optical fibers is disposed at an angle beta to the central longitudinal axis of said precursor sandwich.

15. The method of any one of claims 7 to 14, including the additional steps of cutting said precursor sandwich adjacent an edge which is remote from said first trench, and breaking away a portion of said top plate thereby exposing an end of said at least one bare exposed optical fiber or ends of the plurality of parallel bare exposed optical fibers; and
polishing said exposed end or ends

16. The method of claim 15, wherein the cut is tilted at an angle gamma to the vertical.

17. The method of claim 15, or claim 16, wherein the cut is cut completely through said top plate but only partly through said lower plate.

18. The method of claim 15, claim 16 or claim 17, wherein said cut is disposed at an angle beta to the longitudinal axis of said precursor sandwich.

19. The method of any one of claims 15 to 18, wherein said bare exposed optical fiber or said plurality of parallel bare exposed optical fibers are disposed at an angle to the longitudinal axis of said precursor sandwich.

20. The method of any one of claims 7 to 19, including the step of breaking said bottom plate of said precursor sandwich along said first trench, and removing a major unglued section of said bottom plate;
thereby providing a half-sandwich including said at least one bare exposed optical fiber or said plurality of parallel bare exposed optical fibers, both within said at least one groove or within said plurality of parallel grooves and depending from a face of said top plate.

21. The method of any one of claims 7 to 20, including the additional steps of breaking said top plate of said half-sandwich along said first trench of said top plate, and removing a major unglued section of said top plate;
thereby providing a full sandwich including a bare cantelevered optical fiber or a plurality of parallel bare exposed cantelevered optical fibers, which extend along the longitudinal axis of said full sandwich.

22. A method for the production of a waveguide, comprising the steps of:
providing a waveguide substrate, said waveguide substrate having two opposed lateral ends, each the lateral end including a plurality of parallel longitudinal grooves therein, and a central region abutting said lateral ends, said central region including a plurality of optical-fiber-coupling structures which abut said plurality of parallel longitudinal grooves;
providing two half-sandwiches as claimed in any one of claims 15 to 20; and
securing an associated said half-sandwich to an associated lateral end of said waveguide substrate, with said bare optical fibers within said plurality of parallel grooves of said waveguide substrate, and also in contact with said optical fiber coupling structures.

23. A method for the production of a waveguide, comprising the steps of:
providing a waveguide substrate, said waveguide substrate having two opposed lateral ends, each the lateral end including a plurality of parallel longitudinal grooves therein, and a central region abutting the lateral ends, said central region including a plurality of optical-fiber-coupling structures which abut said plurality of parallel longitudinal grooves;
providing two full sandwiches as claimed in claim 21; and
securing an associated said full sandwich to an associated lateral end of said waveguide substrate, with said bare optical fibers within said plurality of parallel grooves of said waveguide substrate, and also in contact with said optical fiber coupling structures.

24. A substrate for supporting at least one optical fiber, said substrate comprising:
a base substrate of a suitable material;
a longitudinally-extending strain-relief area at one end thereof along a longitudinal axis thereof;
at least one longitudinally-extending groove along said longitudinally-extending axis, said at least one longitudinally-extending groove abutting said strain-relief area; and
at least a first transversely-extending trench across said substrate.

25. A substrate for supporting a plurality of optical fibers, said substrate comprising:
a base substrate of a suitable material;
a longitudinally-extending strain-relief area at one end thereof along a longitudinal axis thereof;
a plurality of parallel, longitudinally-extending grooves along said longitudinally-extending axis, said plurality of parallel, longitudinally-extending grooves abutting said strain-relief area; and
at least a first transversely-extending trench across said substrate.

26. The substrate of claim 24 or claim 25, wherein the strain-relief area extends longitudinally on both lateral sides of said first trench.

27. The substrate of claims 24 or claim 25, wherein said strain-relief area extends longitudinally from said first trench only to said one end thereof.

28. The substrate of claim 24 or claim 25, wherein the strain-relief area extends longitudinally from the one end thereof to stop short of the first trench.

29. The substrate of any one of claims 24 to 28, including a second transversely-extending trench across said substrate at a location remote from said first trench and adjacent an end of said substrate which is remote from said first trench.

30. A precursor sandwich which supports at least one optical fiber, said precursor sandwich comprising:
(a) a bottom plate in the form of a base substrate of a suitable material, a longitudinally extending strain-relief area at one end thereof along a longitudinal axis thereof, at least one longitudinally-extending groove along said longitudinally-extending axis, said at least one longitudinally-extending groove abutting said strain-relief area, and at least a first transversely-extending trench across said substrate;
(b) a top plate in the form of a base substrate of a suitable material, a longitudinally-extending strain-relief area at one end thereof along a longitudinal axis thereof, at least one longitudinally-extending groove along said longitudinally-extending axis, said at least one longitudinally-extending groove abutting said strain-relief area, and at least a first transversely-extending trench across said substrate;
(c) at least one optical fiber within said strain-relief area of either said bottom plate or the top plate, and at least one bare exposed optical fiber within said at least one longitudinally-extending groove of either said bottom plate or said top plate;
wherein:
(d) the precursor sandwich comprises said top plate which is superposed over said bottom plate, with said at least one optical fiber therebetween in said strain-relief area, and with said at least one bare optical fiber in said at least one longitudinally-extending groove, and further in which a minor section of said top plate and said bottom plate of said precursor sandwich has been glued together.

31. A precursor sandwich which supports a plurality of parallel optical fibers, said precursor sandwich comprising:
(a) a bottom plate in the form of a base substrate of a suitable material, a longitudinally-extending strain-relief area at one end thereof along a longitudinal axis thereof, a plurality of parallel, longitudinally-extending grooves along said longitudinally-extending axis, said plurality of parallel, longitudinally-extending grooves abutting said strain-relief area, and at least a first transversely-extending trench across said substrate;
(b) a top plate in the form of a base substrate of a suitable material, a longitudinally-extending strain-relief area at one end thereof along a longitudinal axis thereof, a plurality of parallel, longitudinally-extending grooves along said longitudinally-extending axis, said plurality of parallel, longitudinally-extending grooves abutting said strain-relief area, and at least a first transversely-extending trench across the substrate;
(c) an array of optical fibers within said strain-relief area of either said bottom plate or said top plate, and a plurality of parallel, bare exposed optical fibers within said plurality of parallel, longitudinally-extending grooves of either said bottom plate or said top plate;
wherein:
(d) said precursor sandwich comprises the top plate which is superposed over said bottom plate, with said array of optical fibers therebetween in said strain-relief area, and with said plurality of parallel, bare optical fibers in said plurality of parallel, longitudinally-extending grooves, and further in which a minor section of said top plate and said bottom plate of said precursor sandwich has been glued together.

32. A precursor sandwich which supports at least one optical fiber, said precursor sandwich comprising:
(a) a bottom plate in the form of a base substrate of a suitable material, a longitudinally-extending strain-relief area at one end thereof along a longitudinal axis thereof, at least one longitudinally-extending groove along said longitudinally-extending axis, said at least one longitudinally-extending groove abutting said strain-relief area, a first transversely-extending trench across said substrate, and a second transversely-extending trench across said substrate remote from said first trench and adjacent an end of the substrate which is remote from said first trench;
(b) a top plate in the form of a base substrate of a suitable material, a longitudinally-extending strain-relief area at one end thereof along a longitudinal axis thereof, at least one longitudinally-extending groove along said longitudinally-extending axis, said at least one longitudinally-extending groove abutting said strain-relief area, a first transversely-extending trench across said substrate and a second transversely-extending trench across said substrate remote from said first trench and adjacent an end of said substrate which is remote from said first trench;
(c) at least one optical fiber within said strain-relief area of either said bottom plate or said top plate, and at least one bare optical fiber within said at least one longitudinally-extending groove of either said bottom plate or said top plate;
wherein:
(d) the precursor sandwich comprises said top plate which is superposed over said bottom plate, with said at least one optical fiber therebetween in said strain-relief area, and with said at least one bare optical fiber in said at least one longitudinally-extending groove, and further in which a minor section of the top plate and said bottom plate of the precursor sandwich has been glued together.

33. A precursor sandwich which supports a plurality of parallel optical fibers, said precursor sandwich comprising:
(a) a bottom plate in the form of a base substrate of a suitable material, a longitudinally-extending strain-relief area at one end thereof along a longitudinal axis thereof, a plurality of parallel, longitudinally-extending grooves along said longitudinally-extending axis, said plurality of parallel, longitudinally-extending grooves abutting said strain-relief area, a first transversely-extending trench across said substrate and a second transversely-extending trench across said substrate remote from said first trench and adjacent an end of said substrate which is remote from said first trench;
(b) a top plate in the form of a base substrate of a suitable material, a longitudinally-extending strain-relief area at one end thereof along a longitudinal axis thereof, a plurality of parallel, longitudinally-extending grooves along said longitudinally-extending axis, said plurality of parallel, longitudinally-extending grooves abutting said strain-relief area, a first transversely-extending trench across said substrate, and a second transversely-extending trench across said substrate remote from said first trench and adjacent an end of said substrate which is remote from said first trench;
(c) an array of optical fibers within said strain-relief area of either said bottom plate or the top plate, and a plurality of parallel, bare exposed optical fibers within the plurality of parallel, longitudinally-extending grooves of either said bottom plate or said top plate;
wherein:
(d) said precursor sandwich comprises the top plate which is superposed over said bottom plate, with said array of optical fibers therebetween in said strain-relief area, and with said plurality of parallel, bare optical fibers in said plurality of parallel, longitudinally-extending grooves, and further in which a minor section of said top plate and said bottom plate of said precursor sandwich has been glued together.

34. The precursor sandwich of any one of claims 30 to 33, wherein said strain-relief area extends longitudinally on both lateral sides of said first trench.

35. The precursor sandwich of any one of claims 30 to 33 24, wherein said strain-relief area extends longitudinally from said first trench only to said one end thereof.

36. The precursor sandwich of any one of claims 30 to 33, wherein said strain-relief area extends longitudinally from said one end thereof to stop short of said first trench.

37. The precursor sandwich of any one of claims 30 to 33, wherein said at least one optical fiber or said array of optical fibers, and said at least one bare optical fiber or said plurality of parallel bare optical fibers, is disposed at an angle beta to the central longitudinal axis of said precursor sandwich.

38. The precursor sandwich of any one of claims 30 to 33, in which said precursor sandwich has been cut adjacent an end which is remote from said first trench, and in which a portion of said top plate has been broken away;
thereby providing an exposed end of an optical fiber or exposed ends of said optical fibers.

39. The precursor sandwich of claim 38 in which said exposed optical fiber end or ends have been polished.

40. The precursor sandwich of claim 38 or claim 39, wherein the cut is tilted at an angle to the vertical.

41. The precursor sandwich of claim 38, claim 39 or claim 40, wherein said cut is in the form of a cut which has been cut completely through the top plate but only partly through said bottom plate.

42. The precursor sandwich of any one of claims 38 to 41, wherein said cut is disposed at an angle to the longitudinal axis of said precursor sandwich.

43. The precursor sandwich of any one of claims 38 to 42, wherein said bare exposed optical fiber or the plurality of parallel exposed optical fibers is, or are, disposed at an angle to the longitudinal axis of the precursor sandwich.

44. A half-sandwich comprising the precursor sandwich of any one of claims 30 to 43, in which the bottom plate has been broken away along the first trench thereof, in which a major unglued portion of said bottom plate has been removed; and whereby:
said half-sandwich includes said optical fiber array and at least one bare exposed optical fiber which is within the at least one groove, or the plurality of parallel exposed optical fibers are within the plurality of parallel grooves, said at least one bare exposed optical fiber, or said plurality of parallel exposed optical fibers depending from a face of said top plate and along the longitudinal axis of said half-sandwich.

45. A full sandwich comprising the half-sandwich of claims 44, in which the top plate has been broken away along the first trench thereof, in which a major unglued portion of said top plate has been removed; and whereby:
said full sandwich includes said optical fiber array and at least one bare exposed optical fiber which is cantelevered from said remaining minor portion of said top plate and said bottom plate, or said plurality of parallel exposed optical fibers which are cantelevered from said remaining minor portion of said top plate and said bottom plate and along the longitudinal axis of said full sandwich.

46. A waveguide comprising:
a waveguide substrate having two opposed lateral ends, each said lateral end including a plurality of parallel longitudinal grooves therein, and a central region abutting both the lateral ends, said central region including a plurality of parallel optical-fiber-coupling structures which abut said plurality of parallel grooves; and
an associated half-sandwich as claimed in claim 44 which is secured to an associated lateral end of the waveguide substrate, with said plurality of parallel exposed optical fibers within said plurality of parallel grooves in the lateral ends of said waveguide substrate, and also on contact with the plurality of parallel optical-fiber-coupling structures.

47. A waveguide comprising:
a waveguide substrate having two opposed lateral ends, each said lateral end including a plurality of parallel longitudinal grooves therein, and a central region abutting both the lateral ends, said central region including a plurality of parallel optical-fiber-coupling structures which abut said plurality of parallel grooves; and
an associated fill sandwich as claimed in claim 45 which is secured to an associated lateral end of said waveguide substrate, with said plurality of parallel exposed optical fibers within said plurality of parallel grooves in the lateral ends of the waveguide substrate, and also on contact with said plurality of parallel optical-fiber-coupling structures.
